(19) United States
(12) Patent Application Publication
(10) Pub. No.: US 2006/0016085 A1
(43) Pub. Date: Jan. 26, 2006

(54) Management system for surveying instrument and storage medium used in management system for surveying instrument

(75) Inventors: Masaaki Imamura, Itabashi-ku (JP); Yoshihiro Motoki, Itabashi-ku (JP); Yoshikatsu Miyao, Itabashi-ku (JP)

Correspondence Address: NIELDS & LEMACK, 176 EAST MAIN STREET, SUITE 7, WESTBORO, MA, 01581, US

(73) Assignee: Kabushiki Kaisha TOPCON

(21) Appl. No.: 11/166,983

(22) Filed: Jun. 24, 2005

(30) Foreign Application Priority Data
Jul. 26, 2004 (JP) 2004-217574

(51) Int. Cl. G01C 5/00

(52) U.S. Cl. 33/290

(57) ABSTRACT

A management system for a surveying instrument, comprising a surveying instrument having a storage unit capable to rewrite and a display unit where display is given based on data written in the storage unit, a first computer capable to transmit the data to the storage unit, and a first storage medium capable to read by the first computer, wherein a program developable by the first computer is stored in the first storage medium, the first computer prepares the data by the program, and the first computer can write the data to the storage unit.

### BACKGROUND OF THE INVENTION

The present invention relates to a management system for a surveying instrument, which facilitates security management to identify an owner, a management section, a staff in charge of management, a property section or an user, etc. of the surveying instrument and which facilitates management of date (or term) such as a period of lease and time of maintenance, etc. The present invention also relates to a storage medium to be used in the management system for the surveying instrument.

In the past, a surveying instrument manufactured by a manufacturer has been distributed and sold from the manufacturer to sales agents, and from the sale agents to users. In case a user purchases and uses a single surveying instrument, it is easier to carry out management on an owner of the surveying instrument and to execute management on data such as maintenance time. However, in case the user is a large-scale company or the like and owns many surveying instruments, the surveying instruments are provided to many sections and departments in the company, and the surveying instruments are then delivered from the management section of each of the departments to many individual users.

In case the user is a rental dealer or a lease dealer, it has been practiced in the past to conclude contracts with the rental dealer or the lease dealer, and the surveying instruments are rent or leased to each rental dealer or lease dealer depending on the contents of the contracts.

When the surveying instruments are placed under management at the management section or at the destination of lease or the like, it is necessary to have an identification number to identify each individual surveying instrument. A nameplate with the identification number is attached on each surveying instrument or the identification number is marked or graved on the surveying instrument.

The identification number is entered on a management ledger or inputted to a personal computer. The surveying instrument, which is specified by the identification number, is managed according to the management lodger or the personal computer with respect to which staff uses the surveying instrument, when is the time limit of a lease period or when is the maintenance time.

In case the management section for the surveying instrument performs management on a lease period and maintenance time of each surveying instrument by using the identification number recorded in the management lodger or the personal computer, it is necessary to identify the place where the surveying instrument is now located. Therefore, the user of the surveying instrument must report the location of the surveying instrument to the management section and must confirm the lease period or the time for maintenance. Also, the management section must confirm and must update the data with respect to the location and the section or the staff to be contacted to the newest data by collating with the identification number of each surveying instrument. In this respect, the management on the location of the surveying instrument and the management on date have required complicated procedure for both the users and the management sections.

Further, in case the surveying instruments are placed under management by using identification numbers, and when many surveying instruments are used at the same place, e.g. when surveying operation and construction work are carried out in a large-scale project and many companies are participating in the project, the user cannot identify whether it is the surveying instrument under management by the user unless the identification number is collated with the records on the ledger or on the personal computer. If a user does not pay special attention on the identification number of the surveying instrument at all times, the user may erroneously use a surveying instrument of other user. Also, if the surveying instrument is placed under poor management, the surveying instrument may be mixed up or lost among the surveying instruments of the other companies. In such case, much time and labor must be wasted for the confirmation of the surveying instrument and to find out whether the surveying instrument is really the instrument used by the user. If the nameplate comes apart from the instrument or the carved number becomes unintelligible and the identification number cannot be confirmed, it is difficult to identify each individual surveying instrument.

Also, when a surveying instrument is stolen and the nameplate is removed or the carved number is erased, it is difficult to identify the surveying instrument and to identify to which organization the surveying instrument belongs.

As described in JP-A-2002-365052, rapid progress and propagation of electronic technique have been seen in the field of the surveying instrument in recent years, and new types of the surveying instruments have been developed, on which various types of information, e.g. maintenance time, are displayed on the display unit.

### SUMMARY OF THE INVENTION

It is an object of the present invention to provide a management system for a surveying instrument, by which it is possible to carry out date management and security management by each surveying instrument by itself and to simplify the complicated management procedure for the surveying instruments, and to easily differentiate individual surveying instruments from each other by carrying out individual security management for the surveying instrument.

To attain the above object, a management system for a surveying instrument according to the present invention comprises a surveying instrument having a storage unit capable to rewrite and a display unit where display is given based on data written in the storage unit, a first computer capable to transmit the data to the storage unit, and a first storage medium capable to read by the first computer, wherein a program developable by the first computer is stored in the first storage medium, the first computer prepares the data by the program, and the first computer can write the data to the storage unit.

Also, a management system for a surveying instrument according to the present invention comprises a surveying instrument having a storage unit capable to rewrite and a display unit where display is given based on data written in the storage unit, a second computer capable to transmit the data to the storage unit, a second storage medium capable to read by the second computer, a first computer for preparing the second storage medium, and a first storage medium where a main program readable by the first computer is stored, wherein a main program is developed by the first computer, an auxiliary program is provided by the developed main program, the auxiliary program is written in the second storage medium, the second computer prepares the data according to the auxiliary program developed, and the second computer can write the data can be written in the storage unit.

Further, the present invention provides the management system for a surveying instrument as described above, wherein the data is a date management program for executing management of date such as maintenance time, a lease period, an expiration date of a lease period, and an expiration date of a rental period. Also, the present invention provides the management system for a surveying instrument as described above, wherein the data is a security management program for performing display to identify an owner, a staff in charge of management or the like on a display unit of the surveying instrument. Further, the present invention provides the management system for a surveying instrument as described above, wherein the main program performs display to identify a preparer of the auxiliary program when display is performed on a display unit based on the data prepared by the auxiliary program.

The present invention provides a storage medium in the management system for a surveying instrument as described above, wherein the programs are stored. Also, the present invention provides a storage medium in the management system for a surveying instrument as described above, wherein the auxiliary programs are stored.

According to the present invention, a management system for a surveying instrument comprises a surveying instrument having a storage unit capable to rewrite and a display unit where display is given based on data written in the storage unit, a first computer capable to transmit the data to the storage unit, and a first storage medium capable to read by the first computer, wherein a program developable by the first computer is stored in the first storage medium, the first computer prepares the data by the program, and the first computer can write the data to the storage unit. As a result, the data which is necessary to be written in the surveying instrument can be provided in a storage medium, and the contents of the storage medium displayed on the display unit can be prepared by the provider. This makes it possible to provide display contents for each individual surveying instrument, to differentiate the surveying instruments from each other and to improve the added value of the surveying instrument.

Further, according to the present invention, a management system for a surveying instrument comprises a surveying instrument having a storage unit capable to rewrite and a display unit where display is given based on data written in the storage unit, a second computer capable to transmit the data to the storage unit, a second storage medium capable to read by the second computer, a first computer for preparing the second storage medium, and a first storage medium where a main program readable by the first computer is stored, wherein a main program is developed by the first computer, an auxiliary program is prepared by the developed main program and prepared by the main program is written in the second storage medium, the second computer prepares the data according to the auxiliary program developed, and the second computer can write the data can be written in the storage unit. As a result, the data which is necessary to be written in the surveying instrument can be provided in a storage medium. The contents of the storage medium to be displayed on the display unit can be prepared individually by a first storage medium provider and a second storage medium provider. The specifying information of each provider can be given as the display content of each individual surveying instrument. Thus, it is possible to differentiate the surveying instruments from each other and to improve the added value of the surveying instruments.

Also, according to the present invention, in the management system for a surveying instrument as described above, the data is a date management program for executing management of date such as maintenance time, a lease period, an expiration date of a lease period, and an expiration date of a rental period. As a result, it is possible to perform date management only based on the displaying on the surveying instrument without confirming management information on the ledger or the like, and the management work can be extensively simplified.

Further, according to the present invention, in the management system for a surveying instrument as described above, the data is a security management program for performing display to identify an owner, a staff in charge of management or the like on a display unit of the surveying instrument. Thus, the owner, the staff in charge of management, etc. can be identified only based on the display on the surveying instrument without confirming the management information on the ledger or the like. This facilitates storage management of the surveying instrument and makes it possible to eliminate loss of the surveying instrument or indefiniteness of the belonging of the surveying instrument.

Also, according to the present invention, in the management system for a surveying instrument as described above, the main program performs display to identify a preparer of the auxiliary program when display is performed on a display unit based on the data prepared by the auxiliary program. This makes it possible to place the surveying instruments under easier management in case where information and data on owners, management sections and users of the surveying instrument do not agree with each other.

### BRIEF DESCRIPTION OF THE DRAWINGS

FIG. 1 is a drawing to show a system arrangement of a first embodiment of the present invention;

FIG. 2 is a drawing to show a system arrangement of a second embodiment of the present invention;

FIG. 3 is a perspective view of a surveying instrument according to the present invention;

FIG. 4 is a block diagram of a surveying instrument according to the present invention;

FIG. 5 is a drawing to explain a display of a date management program for the surveying instrument;

FIG. 6 is a drawing to show an example of an alarm display to urge maintenance of the date management program;

FIG. 7 is a block diagram of a computer according to the present invention; and

FIG. 8 is a drawing to explain an example of a screen display based on a security management program.

### DETAILED DESCRIPTION OF THE PREFERRED EMBODIMENT

Description will be given below on the best mode of the invention for carrying out the present invention referring to the drawings.

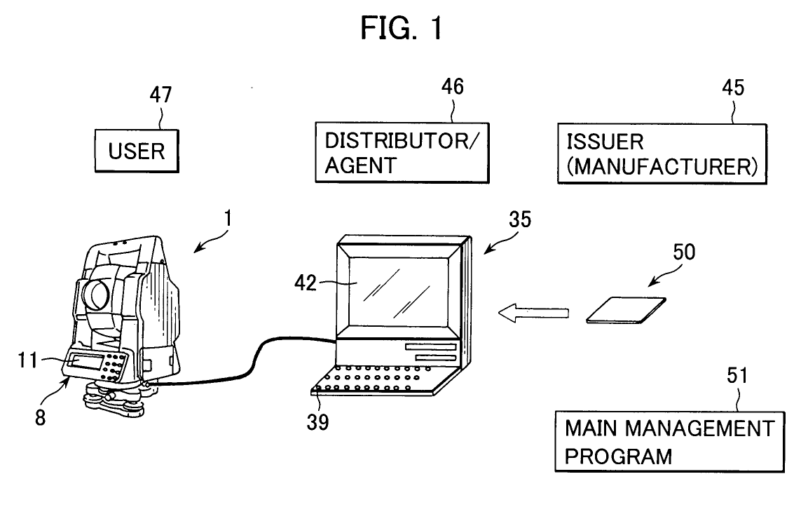

Referring to FIG. 1, description will be given on a first embodiment of the present invention. The first embodiment relates to a case where a user owns a single surveying instrument or a few surveying instruments.

As a basic arrangement, the management system according to the present invention primarily comprises a surveting instrument 1, a copmputer 35 and a storage medium 50. The surveying instrument 1 is manufactured by a manufacturer (issuer) 45 and sold to a user 47 via a distributor/agent 46. The computer 35 is placed under management by the distributor/agent 46, and the computer 35 is connectable to the surveying instrument 1 and able to communicate with the surveying instrument 1 by data communication. The storage medium 50 such as a CD, a FD, a memory card, etc. is issued by the manufacturer 45, and, on the storage medium 50, a main management program 51 is written, which is read and can be developed by the computer 35.

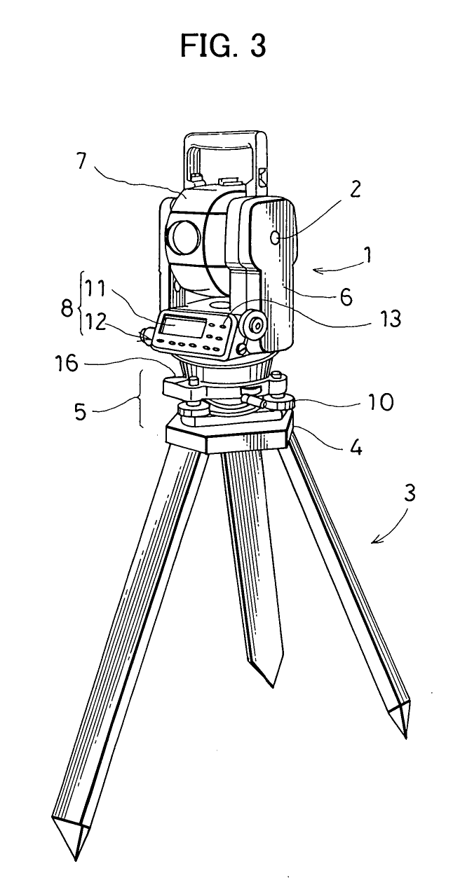

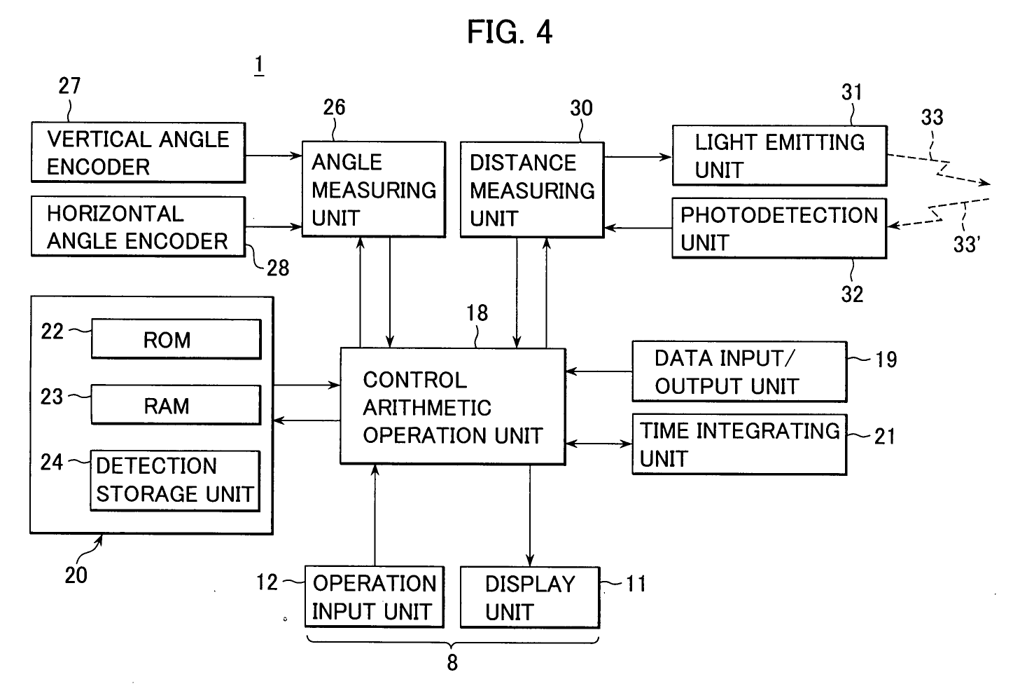

First, referring to FIG. 3 and FIG. 4, description will be given on a total station used as a representative surveying instrument, which has a display unit used in the present embodiment.

As shown in FIG. 3, the surveying instrument 1 is installed on a top 4 of a tripod 3.

The surveying instrument 1 generally comprises a base unit 5 with a leveling function, a frame unit 6 mounted on the base unit 5 so as to be rotatable around a vertical axis, and a telescope unit 7 mounted on the frame unit 6 so as to be rotatable around a horizontal axis.

When the surveying instrument 1 is to be installed, a leveling screws 10 provided on the base unit 5 is rotated, and a posture of the base unit 5 is adjusted so that an air bubble in a circular bubble tube 16 on an upper surface of the base unit 5 is positioned at the center of the circular bubble tube 16.

An operation unit 8 is arranged on a lower portion of the frame unit 6, and a main switch 2 to operate the surveying instrument 1 is provided on a lateral side of the frame unit 6. Further, the operation unit 8 comprises a display unit 11 and an operation input unit 12 with a number of pushbuttons as required. The operation unit 8 has an operation surface and a display surface slightly tilted upward so that an operator can easily watch on the surfaces.

The surveying instrument 1 is designed in such manner that the surveying instrument 1 can be easily carried and moved by the operator, and the surveying instrument 1 is manufactured in compact and lightweight design. For this reason, the operation unit 8 is arranged in a limited space. The arrangement of the operation unit 8 itself also must be suitable for space-saving purpose. To reduce the number of pushbuttons, the operation input unit 12 is designed in such manner that the functions of the pushbuttons can be switched over by function keys, and two or more operations can be overlappingly carried out by pressing a single key. Also, the operation input unit 12 has a suspension button 13, which serves as a switch to suspend surveying operation.

For the purpose of providing effective display on a small limited area of the display unit 11, pictures on a screen can be switched over for each content of display. Specifically, in addition to the display of surveying results, measured angles, measured distances, the following data are displayed by switching over the display screen: the setting of the selected mode, the remaining capacity of battery, etc., or, as described later, the text for showing name or designation, and address of an owner or a staff in charge of the management, and logo mark, identification number of the surveying instrument 1, or time of maintenance, term of lease, etc.

The surveying instrument comprises a mechanical portion and an electric circuit portion, etc. The mechanical portion has a moving unit and a driving unit, and the electric circuit portion performs power supply and measurement. The mechanical portion further comprises a smaller mechanical module. Also, the electric circuit portion comprises a smaller electric circuit module in the same manner. Each of the mechanical portion, the mechanical module, the electric circuit portion, and the electric circuit module has elements, which deteriorate over time, and this means that the accuracy may be deteriorated. Also, component parts with limited service life are used in the portions and the elements, and the service life also varies according to each individual module.

The surveying instrument with the arrangement as described above is not guaranteed to operate permanently by maintaining the initial operating conditions, and the surveying instrument may be damaged or involved in trouble as time elapses. Therefore, maintenance should be performed to prevent in advance the surveying instrument from being damaged or getting in trouble.

Maintenance display notifies the time for maintenance so that trouble does not occur on the surveying instrument and it urges and promotes the maintenance. There are two methods to provide maintenance display: a method to regularly display the time for maintenance, and a method to display by detecting the limit before it comes to the limit.

On the display unit 11, the owner of the surveying instrument is displayed. For instance, when the surveying instrument 1 is started, there are displyed name and appellation or designation of the owner, or name and appellation or designation of the staff in charge of management and management section. By switching over the display screen, display of maintenance time, a term or a period of lease, etc. are displayed.

Higher electronic technique has been introduced in the field of the surveying instrument in recent years, and it is now very rare that the user himself reads the values optically. Not only in the measurement of angles but also in distance measurement, the technique of electro-optical distance measurement (light wave distance measurement) is now adopted, and the results of angle measurement and distance measurement are given by optical/electronic elements and calculating circuits.

The display unit 11 of the surveying instrument 1 as shown in FIG. 3 can be driven by using an electronic circuit, which is already incorporated in the surveying instrument 1. The operation can be carried out by programs for the display unit 11, which are installed into the electronic circuit.

FIG. 4 is a schematical block diagram of a module in an electronic circuit unit of the surveying instrument 1. In the figure, reference numeral 18 represents a control arithmetic operation unit, reference numeral 19 represents an input/output unit, reference numeral 20 represents a storage unit, and reference numeral 21 is a time integrating unit. The storage unit 20 comprises ROM 22, RAM 23, and a detection storage unit 24. As to be described later, the surveying instrument 1 is connected with the computer 35 via wired or wireless communication, and data communication can be performed. Numeral 26 represents an angle measuring unit, and numeral 30 represents a distance measuring unit.

Angle detection signals detected by a vertical angle encoder 27 and a horizontal angle encoder 28 are inputted to the angle measuring unit 26. The angle measuring unit 26 determines a vertical angle and a horizontal angle based on the signals from the vertical angle encoder 27 and the horizontal angle encoder 28. The distance measuring unit 30 controls a light emitting unit 31 and emits a distance measuring light 33. A reflected distance measuring light 33′ from an object to be measured (not shown) is received by a photodetection unit 32. Based on a photodetection signal from the photodetection unit 32, the distance measuring unit 30 measures a distance to the object to be measured.

The time integrating unit 21 is used to determine a time elapsed up to the present moment from a predetermined time stored on a main unit of the surveying instrument 1, e.g. time of shipment, and time of completion of maintenance. The elapsed time is integrated by using an internal clock.

The ROM 22 is a read only memory. The ROM 22 stores programs such as a program to control the display on the display unit 11, a program to display a menu screen (as described later), and information of the owner or the staff in charge of management, e.g. the name, the designation, the logo mark, etc. together with the menu screen, a program to execute displayed items displayed on the menu screen, and a date management program where processing procedures to display maintenance information are written. Also, the ROM 22 stores a rewriting program to enable to rewrite the data which are displayed on the display unit 11 when the data such as an ID number, a password or maintenance data are inputted. Further, the ROM 22 stores standard values for the elapsed time required for judging a time, and so on.

The control arithmetic operation unit 18 reads and develops a necessary program from the ROM 22 based on operation from the operation input unit 12 and executes the processing to match the operation. The ROM 22 is a non-volatile memory such as a flash memory. The ROM 22 is writable during power is connected, and the stored content can be maintained even when power is not connected any more. Also, the ROM 22 stores non-erasable data such as the ID number and the password of the surveying instrument 1, the name, the designation, the address, and the logo mark of the owner of the surveying instrument 1, and the name of the management section of the surveying instrument 1.

The RAM 23 is a volatile memory, which can freely read and write. The elapsed time integrated at the time integrating unit 21 is temporarily stored. The stored content is maintained during power is turned on. The stored content is erased when power is turned off.

The detection storage unit 24 is a non-volatile memory such as a flash memory. Data can be written during power is turned on, and the stored content can be maintained even when power is turned off. The elapsed time stored in RAM 23 is periodically stored. Using the time of shipment as reference, maintenance records in the past and recording of repairs, etc. are stored over time.

When the power to the surveying instrument 1 is turned on by the main switch 2, name, designation, address, and the logo mark of the owner of the surveying instrument 1 and designation of the management section of the surveying instrument 1 recorded in ROM 22 are displayed.

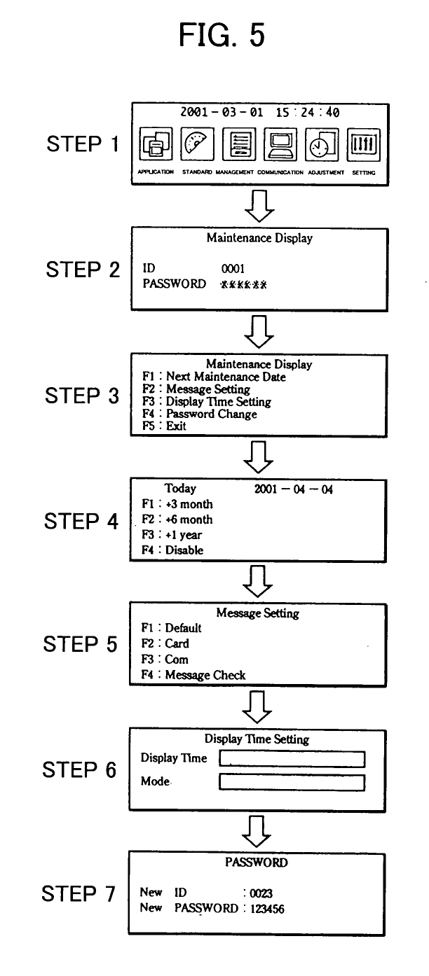

The elapsed time stored in the detection storage unit 24 and the reference time set in the ROM 22 are read, and the elapsed time and the reference time are compared at the control arithmetic operation unit 18. If the elapsed time does not reach the reference time, a normal menu (screen in FIG. 5; Step 1) is displayed without a display of a maintenance alarm. By key operation as required, the time of the next maintenance and the remaining time (duration) up to the maintenance time can be displayed.

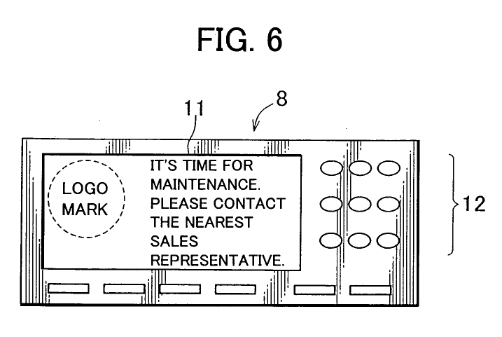

Further, when the power to the surveying instrument 1 is turned on by the main switch 2, the elapsed time stored in the detection storage unit 24 and the reference time set at the ROM 22 are read. The elapsed time and the reference time are compared at the control arithmetic operation unit 18. If the elapsed time has reached the reference time, a maintenance alarm (See FIG. 6) is displayed for a predetermined period of time.

The display of the maintenance alarm is displayed every time the power is turned on until the maintenance procedure is completed by the distributor, or the agent, etc. and the maintenance alarm display is cancelled.

As described above, the date management program is stored at the ROM 22. By starting the date management program, the maintenance conditions can be changed or updated.

Referring to FIG. 5, description will be given on the date management program.

When power is turned on for the surveying instrument 1, a content shown in Step 1 is displayed on the display unit 11. This is a normal menu screen.

On the normal menu screen, operation items such as application, standard, management, communication, adjustment, setting, etc., which are necessary for the operation by the user to operate the surveying instrument 1, are displayed together with icons. Items can be selected by operating the keys on the operation input unit 12.

For example, when the standard is selected, the control arithmetic operation unit 18 reads a menu program relating to the standard operation from the ROM 22. The standard operation is a surveying operation, for instance. The standard operation menu program sequentially displays the procedures relating to the surveying operation on the display unit 11 with the progress of operation. Or, the result of surveying is displayed on the display unit 11, and the result of surveying is recorded or the like on the RAM 23.

It is not desirable that the preset items on the conditions of maintenance are changed by customers or users voluntarily. Therefore, items on the setting and the change of maintenance conditions are not displayed on the normal menu screen.

The date management program is started by operating the keys on the operation unit 12. A first password is needed for the starting of the date management program. The first password to start the date management program is a number, which is common for every type of the product. The operation to start the date management program and to write or change the maintenance conditions is carried out at the distributor/agent 46. Initialization of the maintenance conditions is set by the manufacturer at the time of shipment.

When the date management program is started, a content shown in Step 2 is displayed. The content is a screen to input an ID number and a second password to further execute the date management program. The ID number and the second password to be compared are stored at the detection storage unit 24, and the setting and the inputting of the ID number and the second password are carried out by the manufacturer.

The ID number in this case is a number specifically determined for each distributor/agent 46, and the ID number is set by the manufacturer for each distributor/agent 46. The second password can be set by the distributor/agent 46 as desired.

On the screen shown in Step 2, the ID number and the second password are inputted. If the ID number and the second password thus inputted are correct, a screen of Step 3 is displayed. The screen in Step 3 shows an operation menu for the setting of the maintenance conditions. When F1 is selected from the menu screen by operating the key of the operation input unit 12, a screen of Step 4 is displayed.

On the screen shown in Step 4, there are also selection items for maintenance time by F1-F3. For example, the maintenance time at 3 months, 6 months or one year can be set. If F1 is selected, for instance, an alarm is displayed, which urges maintenance at every 3 months, i.e. an alarm display as shown in FIG. 6 is displayed. The alarm display to urge the maintenance is displayed when the power for the surveying instrument 1 is turned on. The alarm display is displayed for several seconds. Or, the display can be cancelled by pressing any pushbutton as desired on the operation input unit 12.

When such characters and icons are displayed, a display portion of a certain size is required. Attention cannot be aroused in case such alarm is displayed when power is turned off at the completion of operation. The display at the middle of operation results in the interruption of the operation. If maintenance is totally entrusted to the user, the user may often forget the maintenance, and it is more advantageous that the display is given at the time immediately after power is turned on.

If F4 is selected, the function of maintenance alarm display is cancelled. In this case, the distributor/agent 46 puts the time of maintenance under management. When the ENTER key is pressed after the setting, the screen goes back to the menu screen of Step 3.

When F2 is selected on the screen of Step 3, it is possible to set the contents to be displayed on the display unit 11 at the time of maintenance, and a screen of Step 5 is displayed.

When F1 is selected on the screen of Step 5, the screen of default as prepared in advance by the manufacturer is used. If F2 is selected, an image data inputted to a memory card or the like by a personal computer can be inputted and set via the card. In this case, the card can be applied to a type of surveying instrument, which has a card slot on a main unit.

If F3 is selected, a personal computer, etc. is connected, and an image data for the display can be obtained from the personal computer.

If F4 is selected, the display contents under setting or already set can be displayed temporarily on the display unit 11, and the contents can be confirmed. By pressing the ENTER key on the operation input unit 12 after the setting, the screen goes back to the menu screen of Step 3.

When F3 is selected on the screen of Step 3, it is possible to set time duration of the maintenance alarm display, e.g. the setting can be made for 3 seconds or 5 seconds (Step 6). It is also possible to set the mode to turn on or off the display contents. When the ENTER key is pressed after the setting of the display time duration and the mode, the screen goes back to the menu screen of Step 3.

When F4 is selected on the screen of Step 3, the screen is turned to the setting screen for the ID number and the password (Step 7). This is the screen to change the ID number and the password when the ID number has been changed or the distributor/agent must change the password.

When the ENTER key is pressed after the setting, the screen goes back to the menu screen of Step 3.

When F5 (EXIT) is selected on the screen of Step 3, it comes off from the date management program, and the screen goes back to the normal menu screen of Step 1.

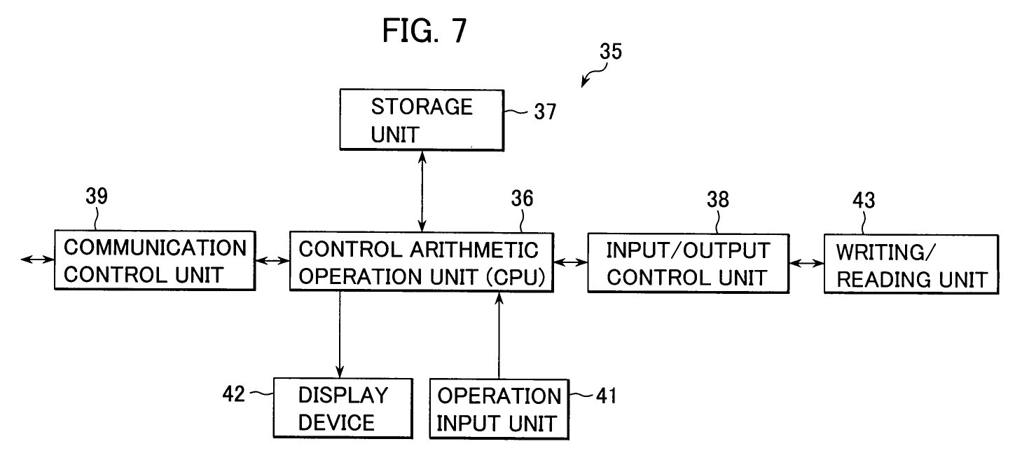

Now, referring to FIG. 7, brief description will be given on the computer 35 (e.g. personal computer (PC)) used in the present embodiment. The computer 35 is placed under management by distributers such as agents, who sells the surveying instrument 1.

The computer 35 comprises a control arithmetic operation unit 36 represented by a CPU, a storage unit 37 such as a HD to store an OS or programs, an input/output control unit 38 to control input/output of data to and from an external system, a communication control unit 39 to control transmission and receiving of the data to and from the external system via an interface such as R232C, USB, etc. and to enable data communication to the surveying instrument 1, an operation input unit 41 represented by a keyboard or the like, a display unit 42 such as a CRT, a liquid crystal display unit, etc., and a writing/reading unit 43 such as a FDD, a CD-R/RW drive, a MO drive, a DVD-R/RW drive, a memory card R/RW drive, etc.

In the storage unit 37, the following programs and conditions are stored: a display program for displaying on the display unit 42, a communication program for transmitting the data and the program read by the writing/reading unit 43 to the surveying instrument 1, a rewriting program for rewriting the contents stored in the storage unit 20 of the surveying instrument 1, and authentication conditions (e.g. an ID number and a password) for specifying the operator when data is transmitted to the surveying instrument 1 and storage are rewritten.

The writing/reading unit 43 can read the main management program 51 stored in the storage medium 50. The main management program 51 thus read is incorporated by the control arithmetic operation unit 36 via the input/output control unit 38, and the main management program 51 is stored in the storage unit 37 and is developed, and the main management program 51 is now ready for the operation. The main management program 51 thus developed is operated by the operation from the operation input unit 41.

Next, description will be given on operation of the management system for the surveying instrument 1 as described above.

In the storage medium 50, the main management program 51 is written by the manufacturer (issuer) 45. The storage medium 50 or the main management program 51 is distributed and given to the distributor/agent 46 with or without charge.

The main management program 51 is read when the storage medium 50 is loaded in the writing/reading unit 43. By inputting the authentication conditions, e.g. the password and the ID number, stored in the main management program 51 via the operation input unit 41, the main management program 51 is stored in the storage unit 37 via the input/output control unit 38 and the control arithmetic operation unit 36. The main management program 51 is developed, and is now ready for the operation.

The main management program 51 prepares the date management program for performing date management such as the management on maintenance time, a lease period, an expiration date of a lease period, an expiration date of a rental period, etc. In the date management program, authentication conditions are set up, which makes it possible to gain access to the date and the date management program such as maintenance time, the lease period, the expiration date of the lease period, or the expiration date of the rental period. By installing the date management program in the surveying instrument 1, various types of information on the date such as maintenance time, lease period, expiration date of lease period, or expiration date of rental period are displayed on and after a predetermined day prior to the day when the date has arrived.

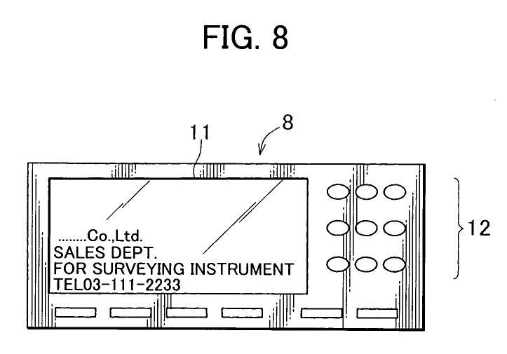

A security management program can be prepared by the main management program 51 in parallel to or independently from the date management program. In the security management program, it is possible to record a designation and a name to identify the companies to become the users, the management section, name of the staff in charge of management and the owner, etc. or a logo mark and the like prepared by the main management program 51, and the authentication conditions to gain access to the security management program can be set. Then, the security management program is installed in the surveying instrument 1, and the designation, the name to specify the company, the management section, the name of the staff in charge of management, the owner, etc. or the logo mark can be displayed on the display unit 11 when the surveying instrument 1 is started. By such displaying, the owner and the staff in charge of management of the surveying instrument 1 can be immediately specified or can be recognized. The images to be displayed are shown in FIG. 8, for instance.

The computer 35 is connected to the surveying instrument 1 so that data communication can be performed. By operating the communication control unit 39, the main management program 51 is operated, and transmission and receiving of data can be carried out to and from the surveying instrument 1 via the communication control unit 39.

The date management program and the security management program are prepared by the main management program 51. The date management program and the security management program are sent to the surveying instrument 1 by operating the communication control unit 39, and the date management program and the security management program are installed in the surveying instrument 1.

When the date management program and the security management program are installed, it is much easier for the user to identify the owner and the staff in charge of management of the surveying instrument 1, and it is easier to own and to put the instrument under management. The dates such as maintenance time, the lease period, the expiration date of the lease period or the expiration date of the rental period are displayed from a predetermined date before the arrival of the date. Thus, these data can be confirmed without collating with the ledger or with the records in the personal computer, and this facilitates date management.

The date management program and the security management program are offered from the distributor/agent 46 to the user 47 under contract with or without charge.

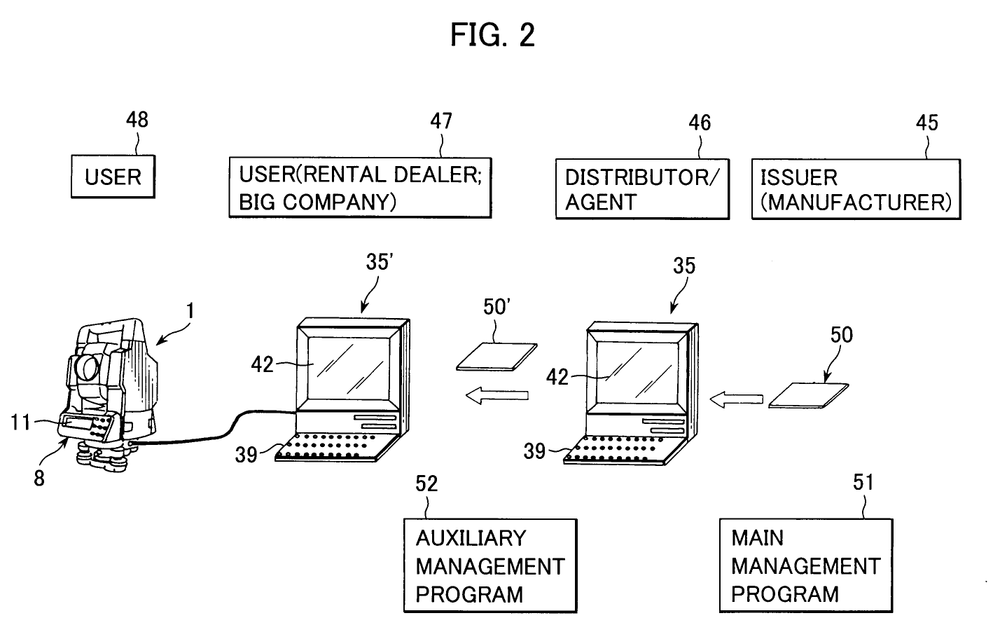

FIG. 2 shows a second embodiment, in which the user 47 is a big company or a big rental dealer with large-scale organization.

In case the user 47 is a big company or a big rental dealer with large-scale organization, it is necessary to have date management and security management of the surveying instruments 1 individually at the user 47. Therefore, the distributor/agent 46 prepares an auxiliary management program 52 by the storage medium 50 offered from the manufacturer 45, i.e. the main management program 51 stored in the storage medium 50, and the auxiliary management 52 is provided to the user 47. The offer of the auxiliary management program 52 to the user 47 is carried out when a storage medium 50′, where the auxiliary management program 52 is written, is prepared and the storage medium 50′ is distributed with or without charge.

The auxiliary management program 52 has the function to definitely indicate that the auxiliary management program 52 has been offered from the distributor/agent 46 to the user 47 and also has the same function as the main management program 51. By loading the strage medium 50′ to a computer 35′, which has equivalent function to the function of the computer 35 owned by the user 47, the auxiliary management program 52 is read and developed. The date management program and the security management program can be prepared at the user 47. By installing the date management program and the security management program to individual surveying instrument 1, it is possible to perform date management and security management on the surveying instruments 1 individually.

When the date management program and the security management program are installed on the surveying instrument 1, the name or the logo mark of the distributor/agent 46 are displayed on the display unit 11. This makes it possible to definitely indicate the seller of the surveying instrument 1, and the designation or the name or the logo mark of the user 47 and the designation or the name or the logo mark of the user 48 are displayed at the same time or separately. By such displaying, the user can immediately identify the company or the rental dealer who owns the surveying instrument 1, and the user of the surveying instrument 1 can be promptly identified or can be recognized.

When the date management program and the security management program which are prepared by the auxiliary management program 52 are installed in the surveying instrument 1, it is much easier for the user 48 to properly identify the distributor or the rental dealer of the surveying instrument 1, and it is much easier to own and to place the surveying instrument 1 under management. Because the dates such as maintenance time, the lease period, the expiration date of lease period, or the expiration date of rental period are displayed on and after a predetermined date before the dates arrives, and this makes it much easier to have the dates under management.

In the above, description has been given in connection with a total station, while the present invention is also applied in the same manner to a surveying instrument with a display unit in the same manner or a leveling system to measure height.

What is claimed is:

1. A management system for a surveying instrument, comprising a surveying instrument having a storage unit capable to rewrite and a display unit where display is given based on data written in said storage unit, a first computer capable to transmit the data to said storage unit, and a first storage medium capable to read by said first computer, wherein a program developable by said first computer is stored in said first storage medium, said first computer prepares the data by said program, and said first computer can write the data to said storage unit.

2. A management system for a surveying instrument, comprising a surveying instrument having a storage unit capable to rewrite and a display unit where display is given based on data written in said storage unit, a second computer capable to transmit the data to said storage unit, a second storage medium capable to read by said second computer, a first computer for preparing said second storage medium, and a first storage medium where a main program readable by said first computer is stored, wherein the main program is developed by said first computer, an auxiliary program is prepared by said developed main program, said auxiliary program is written in said second storage medium, said second computer prepares said data according to said auxiliary program developed, and said second computer can write the data in said storage unit.

3. A management system for a surveying instrument according to claim 1 or 2, wherein said data is a date management program for executing management of date such as maintenance time, a lease period, an expiration date of a lease period, and an expiration date of a rental period.

4. A management system for a surveying instrument according to claim 1 or 2, wherein said data is a security management program for performing display to identify an owner, a staff in charge of management or the like on a display unit of the surveying instrument.

5. A management system for a surveying instrument according to claim 2, wherein said main program performs display to identify a preparer of said auxiliary program when display is performed on a display unit based on the data prepared by said auxiliary program.

6. A storage medium in said management system for a surveying instrument according to claim 1, wherein said program is stored.

7. A storage medium in said management system for a surveying instrument according to claim 2, wherein said auxiliary program is stored.
